(19) United States
(12) Patent Application Publication
(10) Pub. No.: US 2002/0150444 A1
(43) Pub. Date: Oct. 17, 2002

(54) Special bolt and sleeve combination for use in tube-and-node space frame systems connections. The bolt's shaft has a polygonal (hexagonal for example) cross section, and the hollow sleeve has the same inside cross section

(76) Inventor: Khaldoun Mhaimeed, Jeddah (SA)

Correspondence Address: KHALDOUN MHAIMEED, 36500 FORD RD, # 310, WESTLAND, MI, 48185-2211, US

(21) Appl. No.: 09/836,695

(22) Filed: Apr. 17, 2001

(51) Int. Cl. F16B 35/02

(52) U.S. Cl. 411/383

(57) ABSTRACT

This invention is intended to be used in node-and-tube space frame assemblies. The bolt's shaft in the tube assembly would have a hexagonal cross section of its shaft. The inside of the sleeve would have an inside cross section identical to that of the bolt's shank. When the bolt is inserted into the sleeve, and the sleeve is rotated, it will, in turn, turn the bolt. This will eliminate the need of slot in the sleeve, hole in the bolt, and the pin necessary to rotate the bolt when rotating the sleeve.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

Traditional tube-and-node space frames are comprised of tubes with a flat or conical plates welded at their ends. A bolt is inserted through a central hole in the cone and through a sleeve. The sleeve is fitted with a slot, and a pin hole is drilled through the shaft of the bolt. A pin is inserted through the slot in the sleeve and the hole in the bolt to form an integrated unit. When the sleeve is turned it will turn the bolt into the tapped hole in the node, please refer to FIG. 1 (Conventional Space Frame Assembly). Another traditional connection method is to use an O-ring between the round bolt and the sleeve. Using an O-ring between the bolt and sleeve restricts the movement of the bolt through the sleeve, and a complete engagement of the bolt in the node can not be guaranteed. The same would be true if the O-ring is damaged during component or space frame assembly. Furthermore, if all the required bolt threads are allowed to protrude out of the sleeve, the space frame can not be safely assembled. With the new method the bolt's shaft and the inside of sleeve both have a polygonal cross sections. For example, the bolt has a hexagonal cross section (FIG. 6: Bolt with Hexagonal Shaft's Section) and so is the inside of sleeve (FIG. 7: Sleeve with Hexagonal Inside Section). This will allow the bolt to rotate into the node by turning the sleeve (FIG. 5: Bolt & Sleeve Assembly) without the need for slots, pinholes, pins or O-rings.

### BRIEF SUMMARY OF THE INVENTION

In our method, the bolt has a shank with a regular polygonal (hexagonal for example) cross section instead of circular, and the hollow sleeve in which the bolt is inserted has the same polygonal inside cross section. This connection mechanism eliminates the slots in the sleeves, the pins in the bolts, the pins and the O-rings associated with traditional connections utilizing bolts of round cross sections.

### BRIEF DESCRIPTION OF THE SEVERAL VIEWS OF THE DRAWING

FIG. 1: illustrates a standard space frame node-and-tube assembly. It shows the tube assembly to be made of a tube welded to a cone after inserting a bolt through the cone. The bolt is fitted with a sleeve. The sleeve and bolt are joined by a pin that is inserted through a slot in the sleeve and a hole in the round bolt. When the sleeve is turned the bolt will engage in the node.

FIG. 2: shows a detail of the conventional tube end assembly. An isolated plan and section of the round bolt with pin hole are shown. Also shown an isolated plan and section of the sleeve with slot.

FIG. 3: shows a detail of the conventional round bolt with pin hole.

FIG. 4: shows a detail of the conventional slotted sleeve.

FIG. 5: shows an isometric view of the bolt and sleeve assembly.

FIG. 6: shows an isolated plan and section 3-3 of the bolt shank with a hexagonal shaft's section.

FIG. 7: shows an isolated view of the sleeve without a slot. Section 4-4 shows the sleeve with an inside hexagonal section identical to that of the cross section of the bolt's shank.

### DETAILED DESCRIPTION OF THE INVENTION

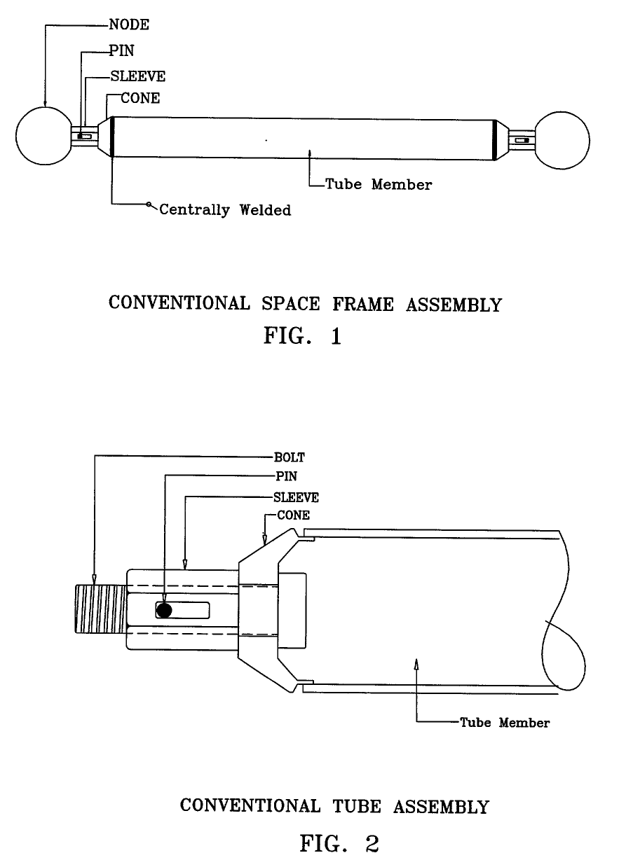

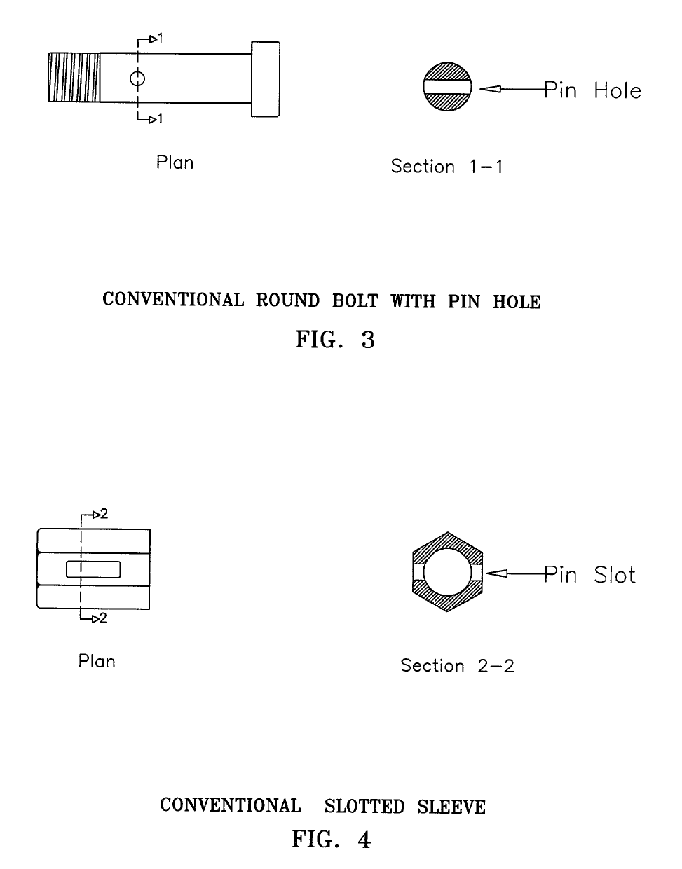

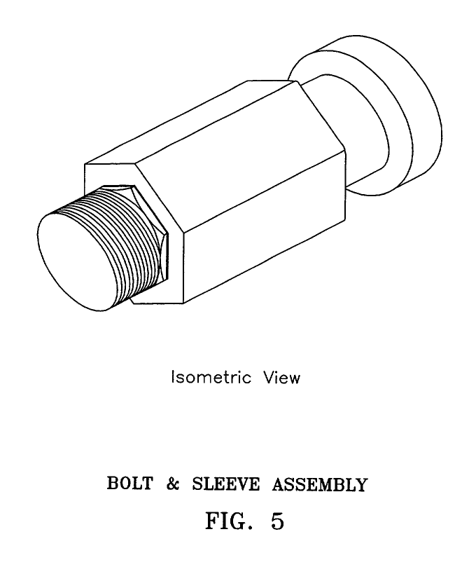

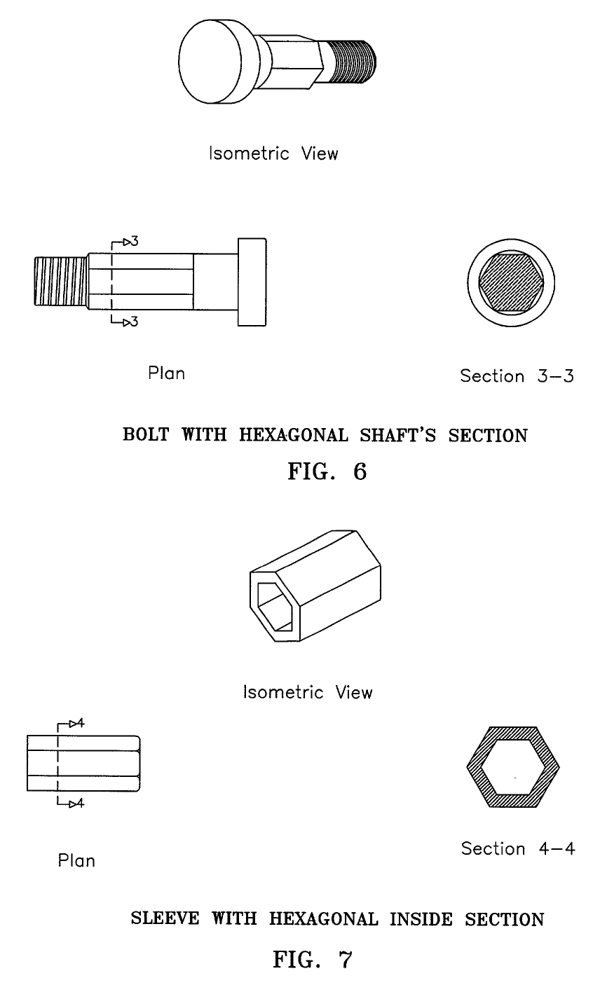

A bolt with a shank of a regular polygonal cross section (hexagonal for example), please refer to FIG. 5, is utilized. The bolt is made of steel and conforms to ASTM A325 or ASTM A490. Also utilized is a hollow sleeve (long nut without threads) with an inside cross section identical to that of the cross section of the bolt's shank. The sleeve is made of steel. The bolt can be inserted into the cone, and through the sleeve to form the assembly in FIG. 3. When the sleeve is rotated it will in turn rotate the bolt with it, and the bolt will engage in the node to form the space frame assembly in FIG. 1. This new system has the following advantages over conventional systems where a round bolt is used:

1. Eliminate the slot in the sleeve.

2. Eliminate the hole in the bolt.

3. Eliminate the O-ring between the bolt and the sleeve.

4. Ease of component assembly (sleeve and bolt) and ease of space frame assembly (tube and nodes).

5. Guarantee of full engagement of the bolt threads into the node.

6. Provide for a better protection against corrosion.

1. I claim that I am the original inventor of a bolt with a regular polygonal (hexagonal for example) cross section of the shank to be used in node-and-tube space frame assemblies:

2. I claim that I am the original inventor of a sleeve with an inside section identical to that of the bolt mentioned in claim number 1. Bolt in claim number 1 and sleeve in claim number 2 are to be used together in node-and-tube space frame assemblies.
